(19) United States
(12) Patent Application Publication
(10) Pub. No.: US 2009/0013448 A1
(43) Pub. Date: Jan. 15, 2009

(54) Accessory with Light Source

(76) Inventor: Lonnie Drosihn, Monkton, MD (US)

Correspondence Address: EDELL, SHAPIRO & FINNAN, LLC, 1901 RESEARCH BOULEVARD, SUITE 400, ROCKVILLE, MD, 20850, US

(21) Appl. No.: 12/171,534

(22) Filed: Jul. 11, 2008

Related U.S. Application Data
(60) Provisional application No. 60/949,225, filed on Jul. 11, 2007.

(51) Int. Cl. A42B 1/06; F21V 21/08

(52) U.S. Cl. 2/209; 362/103

(57) ABSTRACT

An accessory with a source of light is disclosed. In particular, the present invention relates to an accessory that is a device that can be worn on the head of an individual to cover the user's ears.

### REFERENCE TO RELATED APPLICATION

This application claims priority to and the benefit of U.S. Provisional Patent Application No. 60/949,225, filed Jul. 11, 2007, Attorney Docket No. 0100.0086P, the entire disclosure of which is incorporated herein by reference in its entirety.

### BACKGROUND OF THE INVENTION

The present invention relates to an accessory with a source of light. In particular, the present invention relates to an accessory that is a device that can be worn on the head of an individual to cover the user's ears. Such an accessory can be referred to as an ear covering device or an ear warmer.

Many people run before work or afterwards in the evenings at dusk or in darkness, times where visibility is low. Visibility is also affected by the dark clothing worn by many runners which does not reflect light so that runners are not easily seen by motorists. Some individuals attempt to wear white or light-colored clothing or clothing with reflective strips to be more easily seen. These attempts are insufficient as well as attempts by runners to carry an object, such as a flashlight. There is a need for a convenient, light-weight solution to increase safety while not burdening the individual.

### SUMMARY OF THE INVENTION

The present invention provide an accessory, such as an ear covering device, with a source of light that can be seen by others. The source of light is located relative to the accessory in a position or positions in which it is viewable from several directions. In one embodiment of the invention, the light source is disposed on a rear portion of the accessory. In another embodiment, the light source is disposed on a side portion of the accessory. In yet another embodiment, the light source is disposed so that it extends along at least part of the rear portion and at least part of a side portion of the accessory. In one embodiment, the ear covering device includes a light source that can be controlled by the user.

In one embodiment, an ear covering device includes a shell and a frame. The shell can be formed by several fabric membranes that are coupled together to form an interior region into which the frame can be inserted. The frame can have either an adjustable length or a fixed length. In an alternative embodiment, the ear covering device includes a frame and several shell portions that cover a portion of the frame and that are removably coupleable to the frame.

In one embodiment, the ear covering device includes a coupling mechanism that can be used to couple the light source to the ear covering device. In one implementation, the ear covering device includes a shell and the coupling mechanism is a sleeve that is attached to the shell. The sleeve forms a reception that is configured to receive the light source. In another implementation, the coupling mechanism is a receptacle that is formed within the shell of the ear covering device.

In one embodiment, the light source is a light emitting diode (LED). In another embodiment, the ear covering device can include multiple light sources coupled thereto, each of which is an LED.

### BRIEF DESCRIPTION OF THE DRAWINGS

FIG. 1 illustrates a schematic block diagram of an embodiment of an accessory according to the present invention.

FIG. 2 illustrates a schematic block diagram of an alternative embodiment of an accessory according to the present invention.

FIG. 3 illustrates a schematic block diagram of an alternative embodiment of an accessory according to the present invention.

FIG. 4 illustrates a side view of an ear covering device according to the present invention as worn by an individual.

FIG. 5 illustrates a top view of the ear covering device illustrated in FIG. 4.

FIG. 6 illustrates a set of membranes or membrane portions that can be coupled together to form a shell for an ear covering device.

FIG. 7 illustrates another set of membranes or membrane portions that can be coupled together to form another shell for an ear covering device.

FIG. 8 illustrates a top view of an embodiment of a frame of the ear covering device illustrated in FIGS. 4 and 5.

FIG. 9 illustrates a side view of an embodiment of an ear covering device according to the present invention.

FIG. 10 illustrates a top view of the ear covering device illustrated in FIG. 9.

FIG. 11 illustrates a rear view of the ear covering device illustrated in FIG. 9.

FIG. 12 illustrates a cross-sectional side view of the ear covering device illustrated in FIG. 11 taken along line “12”-“12”.

FIG. 13 illustrates a cross-sectional side view of an alternative embodiment of an ear covering device according to the present invention.

FIG. 14 illustrates a side view of an alternative embodiment of an ear covering device according to the present invention.

FIG. 15 illustrates a plan view of the shell of the ear covering device illustrated in FIG. 14 disposed in a planar configuration.

FIG. 16 illustrates a partial cross-sectional view of a portion of the ear covering device illustrated in FIG. 15 taken along line “16”-“16”.

FIG. 17 illustrates a schematic block diagram of an embodiment of a light source according to the present invention.

FIG. 18 illustrates a plan view of an embodiment of a light source according to the present invention.

FIG. 19 illustrates a perspective view of an alternative embodiment of an ear covering device.

FIG. 20 illustrates a perspective view of an alternative embodiment of an ear covering device according to the present invention.

FIG. 21 illustrates a perspective view of an alternative embodiment of an ear covering device according to the present invention.

FIG. 22 illustrates a plan view of an inner surface of the shell of ear covering device illustrated in FIG. 21.

FIG. 23 illustrates a rear view of an alternative embodiment of an ear covering device according to the present invention.

FIG. 24 illustrates a bottom view of an alternative embodiment of an ear covering device according to the present invention.

FIG. 25 illustrates a side view of an alternative embodiment of an ear covering device according to the present invention.

FIG. 26 illustrates a top view of the ear covering device illustrated in FIG. 25.

FIG. 27 illustrates a top perspective view of an alternative embodiment of an ear covering device according to the present invention.

FIG. 28 illustrates a top perspective view of an alternative embodiment of an ear covering device according to the present invention.

### DETAILED DESCRIPTION OF THE INVENTION

Like reference numerals have been used to identify like elements throughout this disclosure. The terms “ear covering device,” “ear protection device,” and “ear warmer” may be used interchangeably herein to refer to a device or structure that is configured to be worn by an individual to cover the user's ears. Such a device can keep the user's ears warm and can be referred to as an accessory. The terms “illumination device,” “illumination source,” “light source,” and “source of light” are used interchangeably herein to refer to a device that is configured to generate a visible output, such as light. In the various embodiments disclosed herein, the color and the intensity level of the light generated by different light sources can vary.

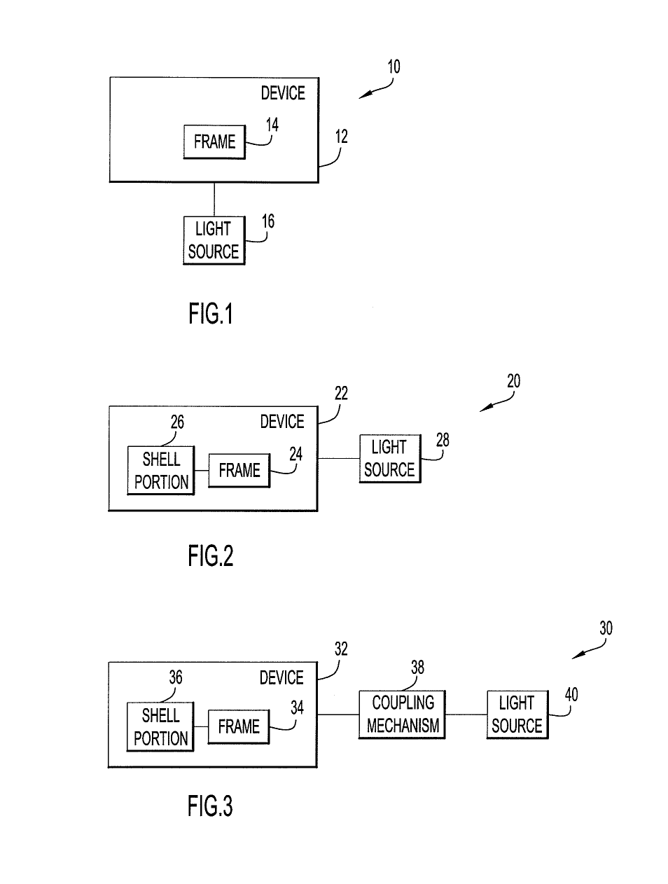

A schematic block diagram of an accessory according to the present invention is illustrated in FIG. 1. In this embodiment, the accessory 10 includes a device 12, such a device for covering a user's ears. The device 12 includes a frame 14 that is configured to retain the device 12 proximate to a user's ears. Accessory 10 also includes a light source 16 that is coupleable to the device 12. The light source 16 is configured to increase the safety of the user when the user wears the device 12. Accordingly, the light source 16 can be disposed on the frame 14 in a position that allows for the light generated by the light source 16 to be seen by other individuals, particularly in at least one direction. Various positions and locations for a light source on an accessory are discussed in detail below.

Referring to FIG. 2, an alternative embodiment of an accessory is illustrated. Accessory 20 includes a device 22, such as an ear covering device, that has a frame 24 and a shell portion 26. The shell portion 26 can be configured to cover a portion of the frame 24 or alternatively, the entire frame 24. The accessory 20 includes a light source 28 that can be coupled to either or both the frame 24 and the shell portion 26.

Referring to FIG. 3, another embodiment of an accessory is illustrated. The accessory 30 includes a device 32 that has a frame 34 and a shell portion 36. The accessory 30 also includes a light source 40 and a coupling mechanism 38 that is configured to facilitate the coupling of the light source 40 to the device 32. Various embodiments of coupling mechanisms are described in detail below.

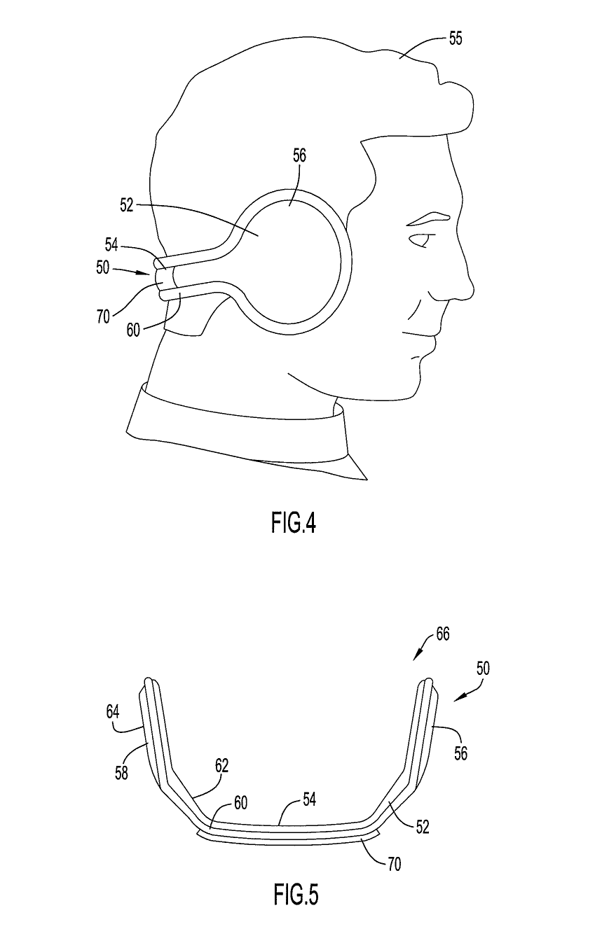

An embodiment of an accessory or an ear covering device is illustrated in FIGS. 4 and 5. The ear covering device 50 is adapted to be worn over the ears of an individual 55. When it is worn, the ear covering device 50 extends around the back of the head and/or neck of the wearer.

The ear covering device 50 includes a shell portion 52 and an internal frame. The shell portion 52 includes a middle or band portion 54 and ear portions 56 and 58 at opposite ends of the middle portion 54. Only one side of the ear covering device 50 is illustrated in FIG. 4. The opposite side of ear covering device 50 is illustrated in FIG. 5. In this embodiment, the middle portion 54 is relatively narrower than the ear portions 56 and 58 (see FIG. 4). In alternative embodiments, the relative dimensions of the middle portion 54 and the ear portions 56 and 58 can vary relative to each other.

As shown in FIG. 4, the ear covering device 50 includes a light source or illumination device 70. In this implementation, the light source 70 is disposed proximate to the rear portion of the ear covering device 50. Thus, if the user wears the ear covering device 50, the light source 70 will be viewable from the rear. When the light source 70 is functioning and generating light, the generated light will alert a person behind or to the side of the user of the user's location and movement.

Referring to FIG. 5, a top view of the ear covering device 50 is illustrated. The ear covering device 50 is illustrated in its deployed configuration 66 in which the ear portions 56 and 58 are spaced apart from each other. This spacing is achieved due to the flexing of the band or middle portion 54 and the ear portions 56 and 58. With the ear portions 56 and 58 spaced apart, the ear covering device 50 can be placed on the head of an individual. The spring force created by the middle portion 54 of the ear covering device 50 causes the ear portions 56 and 58 to engage against the side of the head of the individual 55. The spring force of the band in the ear covering device 50 is contemplated to be sufficient to engage the user's head so that the ear covering device 50 does not fall off. However, the spring force is desired to be limited so that the ear covering device 50 is not uncomfortable to wear.

The ear covering device 50 includes a fabric shell 52 in which a frame is disposed. In one embodiment, the shell 52 includes a binding 60 around the perimeter of the shell 52 and ear covering device 50. Referring to FIG. 5, the shell 52 includes an inner surface 62 and an outer surface 64. When the ear covering device 50 is worn by an individual, the inner surface 62 is disposed proximate to the individual's head, neck and/or ears. The outer surface 64 is disposed on the outer side of the device 50 and exposed away from the individual. In an alternative embodiment, the ear covering device 50 does not include any binding around the perimeter and the membranes are coupled together. In that embodiment, the coupling portion of the membranes is disposed within the interior region of the shell 52.

The position and configuration of light source 70 in this embodiment is illustrated in FIG. 5. In this configuration, the light source 70 extends along the back surface or region of the ear covering device 50. The light source 70 also extends a distance along the side surfaces or regions of the ear covering device 50. This position enables generated light to be seen by an individual behind the wearer or on one of the sides of the user.

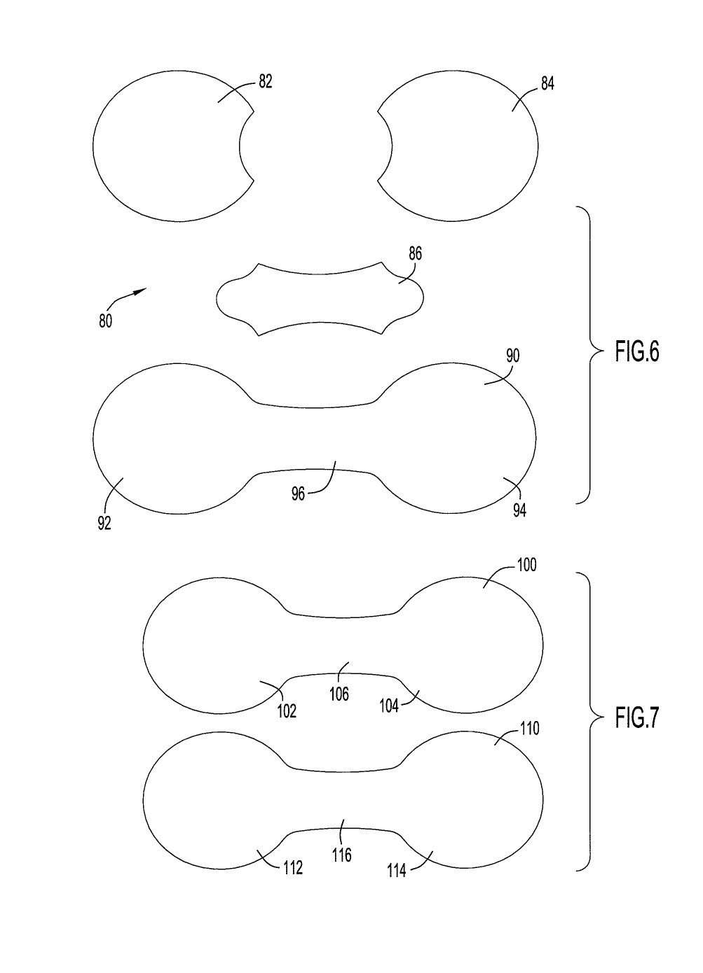

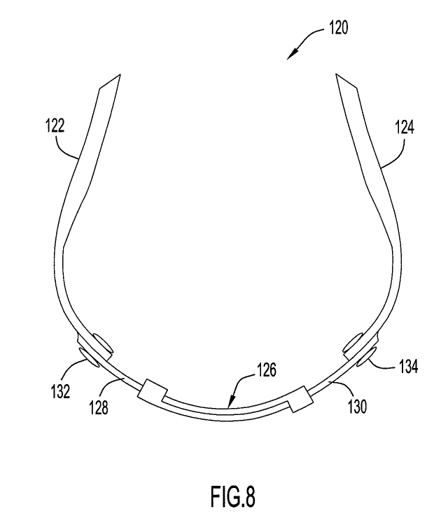

Referring to FIGS. 6 and 7, alternative embodiments of shells for use in construction of an ear covering device are illustrated. The shell includes an inner membrane 80 and an outer membrane 90. In the embodiment illustrated in FIG. 6, the inner membrane 80 comprises two ear membranes 82 and 84 and a middle membrane 86. The outer membrane 90 is a one-piece membrane that has ear portions 92 and 94 and a middle portion 96. The inner membrane 80 and the outer membrane 92 may be coupled using any technology, including but not limited to, sewing, bonding, adhesives, or welding. When the inner membrane 80 and the outer membrane 90 are coupled together, they form the shell and an interior region therebetween.

Referring to FIG. 7, this embodiment of the shell includes an inner membrane 100 and an outer membrane 110. The inner membrane 100 is a one-piece member that includes ear portions 102 and 104 and a middle portion 106. Similarly, the outer membrane 110 is a one-piece member that includes ear portions 112 and 114 and a middle portion 116. The inner membrane 100 and the outer membrane 110 may be coupled using any technology, similar to the membranes illustrated in FIG. 6. When coupled together, the inner membrane 100 and the outer membrane 110 form an interior region therebetween.

An embodiment of a frame that can be used in an ear covering device is illustrated in FIG. 8. The frame 120 is configured to be disposed and retained within the shell of an ear covering device. In this embodiment, the frame 120 includes a band 126 that is adjustable in length. The band 126 includes two slidably coupled band portions 128 and 130 that can be adjusted by a user to change the length of the band 126. The frame 120 includes ear frame members 122 and 124 that are coupled to opposite ends of the band portion 126 by conventional connectors 132 and 134, such as rivets. Each of the connectors 132 and 134 is configured to enable the corresponding ear frame member 122 or 124 to pivot about the connector relative to the band 126. The components of the frame 120 are manufactured from a molded plastic material, such as CRASTIN.

In an alternative embodiment, the ear frame members can be fixedly coupled or integrally formed with the band portion. In another embodiment, the length of the band may be fixed and not adjustable. For example, the band may be formed by a single member or by several pieces that do not move relative to each other. Additionally, the frame used with a shell of the ear covering device can have any configuration and is not limited to the frame illustrated in FIG. 8.

Exemplary ear covering devices, including frames, shells, membranes, and other components of such devices are set forth in U.S. Pat. Nos. 5,835,609; 6,499,146; 6,502,248; and 6,735,784, and the disclosures of each of those four patents is incorporated by reference herein in its entirety for all purposes.

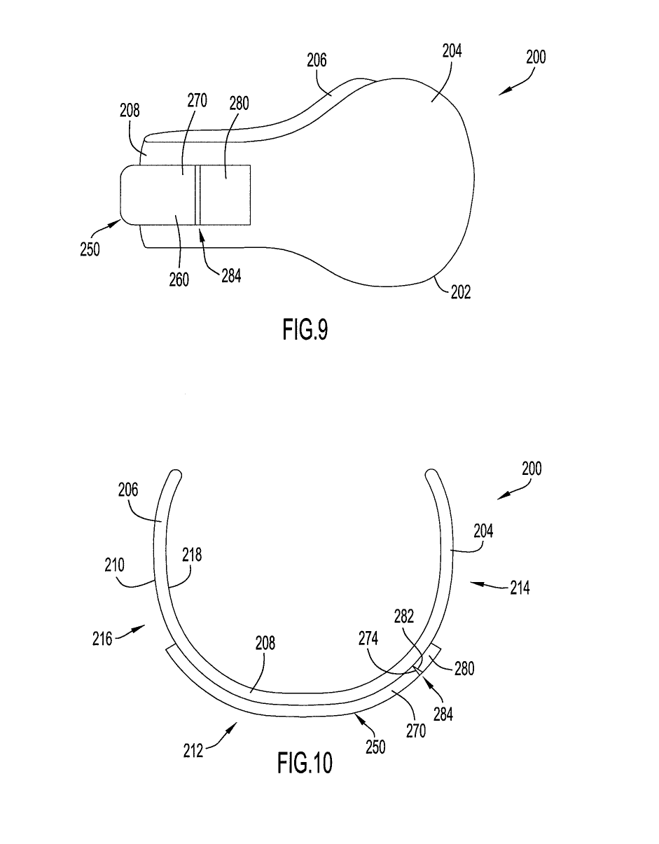

An embodiment of an accessory or an ear covering device according to the present invention is illustrated in FIGS. 9-12. The ear covering device 200 includes a shell 202 that has a frame disposed therein. The shell 202 has ear portions 204, 206 and a middle portion 208 disposed between the ear portions 204 and 206 (see FIG. 10). The shell 202 has an outer surface 210 and an inner surface 218 that is disposed proximate to the user's head and/or ears when the ear covering device 200 is worn by the user. When the ear covering device 200 is worn by a user, several regions or areas relative to the wearer's head can be defined. Referring to FIG. 10, the ear covering device 200 includes a rear region or area 212 and opposite side regions or areas 214 and 216.

Referring to FIG. 12, several components of the shell 202 are illustrated. The shell 202 includes an inner membrane 220 and an outer membrane 222 that form an interior region 224 therebetween. A frame 230 is disposed with the interior region 224. FIG. 12 illustrates a portion of a band of the frame 230.

Ear covering device 200 also includes a light component 250. The light component 250 is located on the ear covering device 200 so that its generated light is visible in the rear region 212 and/or the side regions 214 and 216. The length of the light component 250 determines the range of visibility of the generated light on different sides of the ear covering device 200. In alternative embodiments, the length of the light component 250 can vary and as a result, the range of illumination will change.

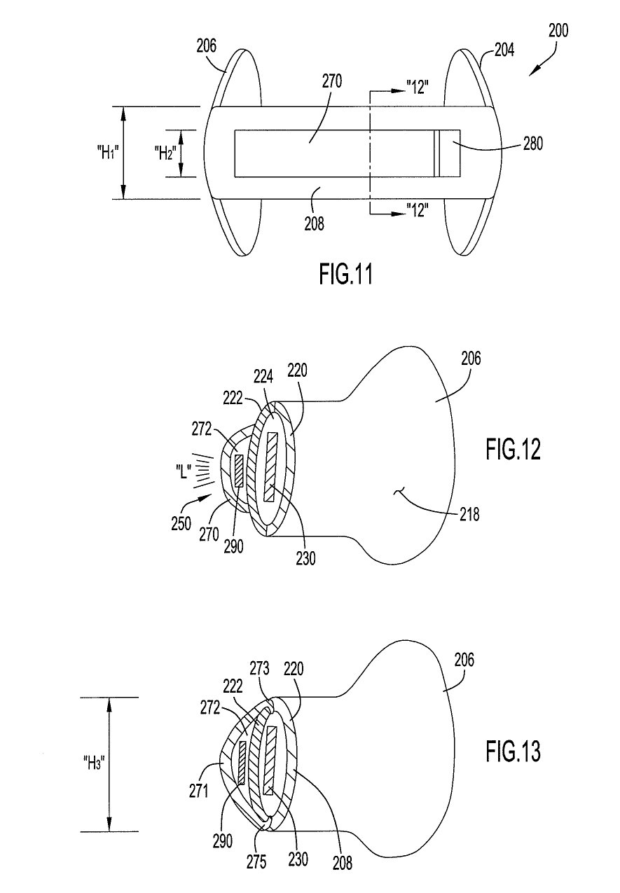

The light component 250 includes a coupling mechanism 260 and a light source 290 (see FIG. 12). The coupling mechanism 260 is configured to support or retain the light source 290 relative to the shell 202 of the ear covering device 200. Referring to FIGS. 9-12, the coupling mechanism 260 includes a sleeve 270 that is coupled to the shell 202. The sleeve 270 and the shell 202 form a receptacle or channel 272 therebetween (see FIG. 12). The sleeve 270 can be coupled to the shell 202 using any conventional techniques or methods, including sewing, adhesives or the like. The coupling mechanism 260 also includes a shorter sleeve 280 that is disposed proximate to sleeve 270 as shown in FIGS. 10 and 11. A receptacle is formed between the shorter sleeve 280 and the outer surface of the shell 202 when the shorter sleeve 280 is coupled to the shell 202.

As shown in FIG. 12, the light source 290 is inserted into the receptacle 272. Light “L” is generated by the light source 290 and passes through the sleeve 270. The sleeve 270 is formed of a lightweight, translucent material. In one embodiment, the sleeve 270 also has reflective properties.

A portion of the light source 290, such as the portion that includes the switch to turn on and off the source 290 (as described below), can be inserted into the receptacle. As illustrated in FIG. 10, sleeve 270 has an end 274 and sleeve 280 has an end 282. The ends 274 and 282 form an opening 284 therebetween through which the illumination device 290 can be inserted. In the embodiment illustrated in FIGS. 9-12, the height “H2” of the sleeve 270 is less than the height “H1” of the middle portion 208 (see FIG. 11).

Referring to FIG. 13, an alternative embodiment of a sleeve for an ear covering device is illustrated. The components of the ear covering device illustrated in FIG. 13 that are the same as those illustrated in FIG. 12 have the same reference numbers. As shown, in this embodiment, the ear covering device includes a sleeve 271 that extends the full height “H3” of the middle portion 208 of the ear covering device. The increase in size of the sleeve 271 allows for a larger or wider light source 290 to be inserted into the receptacle 272.

In this embodiment, the sleeve 271 is coupled to the shell 202 by inserting portions of the upper edge 273 and the lower edge 275 of the sleeve 270 between the membranes 220 and 222. The membranes 220 and 222 and the sleeve 270 can then be coupled together by sewing, adhesives, welding, or the like. An exemplary method of manufacturing an ear warmer is disclosed in U.S. Pat. Nos. 6,502,248 and 6,735,784, the disclosures of each of which have been incorporated by reference herein in their entirety for all purposes.

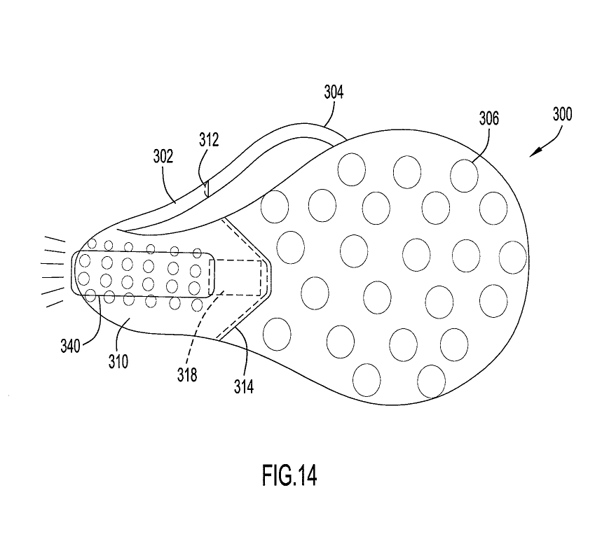

An alternative embodiment of an ear covering device according to the invention is illustrated in FIGS. 14-16. In this embodiment, the ear covering device 300 includes a shell 302 with ear portions 304 and 306 and a middle or band portion 308. Ear covering device 300 includes a coupling mechanism 310, which in this implementation is a sleeve. The sleeve 310 and the outer surface of the shell 302 define a receptacle therebetween. The sleeve 310 includes an end 312 that is coupled to the shell 302 and an end 314 that is releasably coupleable to the shell 302 by a coupler 318, which can be one of a hook and a loop-type fastener. When the end 314 is not coupled to the shell 302, the receptacle can be accessed and a light source 340 can be inserted into the receptacle.

As shown in FIG. 14, the sleeve 310 is disposed on the rear portion of the ear covering device 300. When turned on, the light source 340 in the sleeve 310 generates light that passes through the material of the sleeve 310.

Referring to FIG. 15, the shell 302 is disposed in a planar configuration and entire outer surface of the shell 302 is illustrated. As previously mentioned, sleeve 310 includes ends 312 and 314, with end 312 being sewn to the shell 302 by stitching 316 and end 314 being releasably coupleable to the shell 302 as described above.

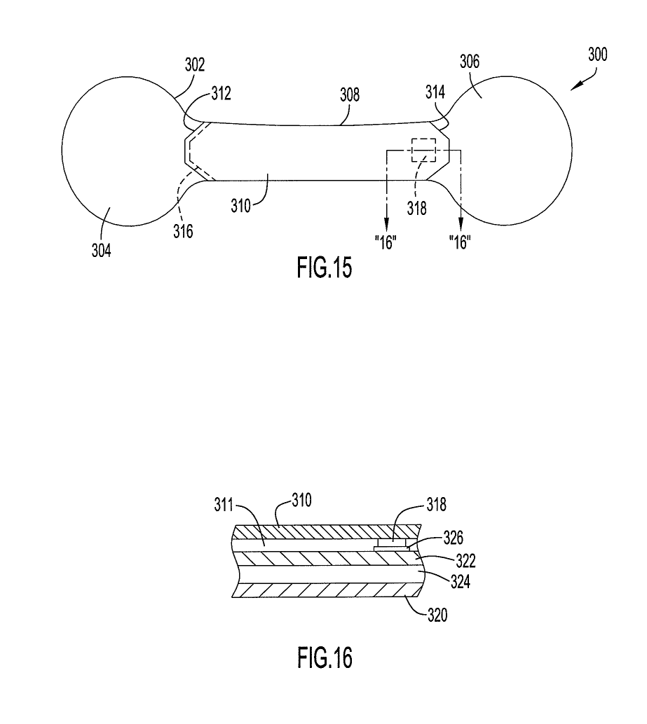

Referring to FIG. 16, a cross-sectional view of the internal components of the shell 302 is illustrated. Inner membrane 320 and outer membrane 322 define an interior region 324 therebetween in which a frame (not shown) is inserted. The sleeve 310 defines receptacle 311 between its inner surface and the outer surface of the outer membrane 322. As described above, the sleeve 310 includes a coupler 318 which is one of a hook and a loop-type coupler. A cooperating one of a hook and loop-type coupler 326 is connected to the shell 302 and aligned with coupler 318. In other embodiments, the couplers 318 and 326 can be different types of cooperating structures, including magnets, a button and slot arrangement, and snap connectors.

A schematic block diagram of a light source or illumination device according to the present invention is illustrated in FIG. 17. In this embodiment, the device 350 includes an electronic or control system 352 that has electrical components, including a power source 354 and a switch 356. Electronically connected to the power source 354 is a light emitting diode (LED) 358, the function of which is controlled by a user via the switch 356. The LED 358 is in communication/contact with an illumination material 360. The illumination material 360 is a material that lights up and outputs light that is introduced to the material. Together the LED 358 and the illumination material 360 form a light source.

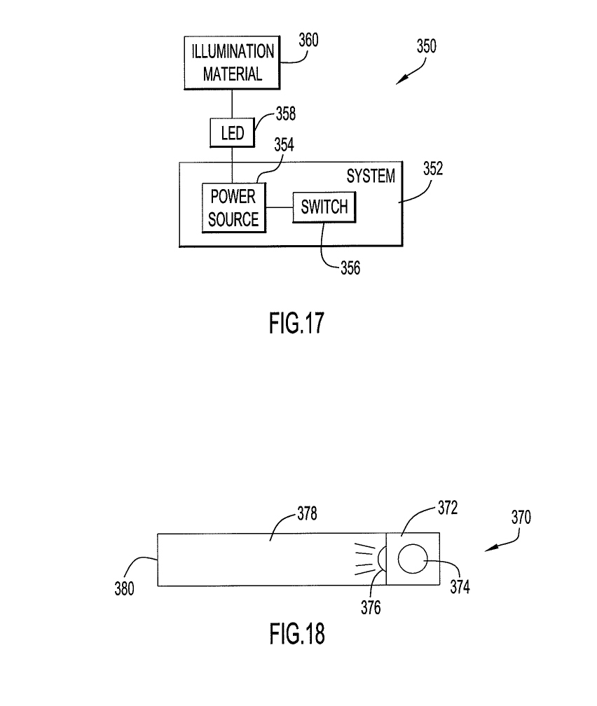

An embodiment of a light source is illustrated in FIG. 18. The light source 370 includes a housing 372 that has a switch 374. The housing 372 includes a circuit board that controls the operation of the light source 370. A power source, such as a 32 volt watch battery, can be utilized. An output device 376, such as an LED, is supported by the housing 372. The LED 376 can be a single color, such as red. In alternative embodiments, multiple LEDs or an LED that outputs multiple colors can be used.

Coupled to the housing 372 is a piece of material 378 that can be illuminated. In this implementation, the material 378 is an elongate member and is made of an extruded polymer, which provides some flexibility to the material 378. The LED 376 is disposed near one end of the material 378 and the other end 380 of the material 378 is free. When the LED 376 is powered, it outputs light into the material 378, with which it is in contact. The member 378 can be easily cut or trimmed to change the length and configuration of the member 378 as desired, depending on the location and space in which the member 378 is disposed.

Actuations of the switch 374 can result in different light output patterns by the LED 376. In one embodiment, when the switch 374 is actuated, the LED 376 is turned on and the LED 376 generates light. When the switch 374 is subsequently actuated, the LED 376 goes into a flashing mode in which it repeatedly turns on and off. Upon the next actuation of the switch 374, the LED 376 is turned off. In other embodiments, various light output patterns can be established. An exemplary light source that is similar to the light source 370 is available from Nite Ize, Inc. The entire disclosure of U.S. Pat. No. 5,879,076 is incorporated by reference herein in its entirety for all purposes.

An alternative embodiment of an ear covering device is illustrated in FIG. 19. Ear covering device 400 includes a frame 402 that is molded and can be formed of a plastic material. The frame 402 includes a band portion 404 and ear portions 406 and 408 that are pivotally coupled to opposite ends of the band portion 404. The ear covering device 400 includes shell portions 410 and 412 that are removably coupled to respective ones of the ear portions 406 and 408 of the frame 402. Exemplary ear covering devices, frames and method of making and using the same are disclosed in U.S. Patent Application Publication No. 2005/0034216A1 (which is the publication of U.S. patent application Ser. No. 10/638,476) and U.S. Patent Application Publication No. 2005/0034218A1 (which is the publication of U.S. patent application Ser. No. 10/693,607), and the entire disclosure of each of these two Patent Application Publications is incorporated by reference in its entirety for all purposes.

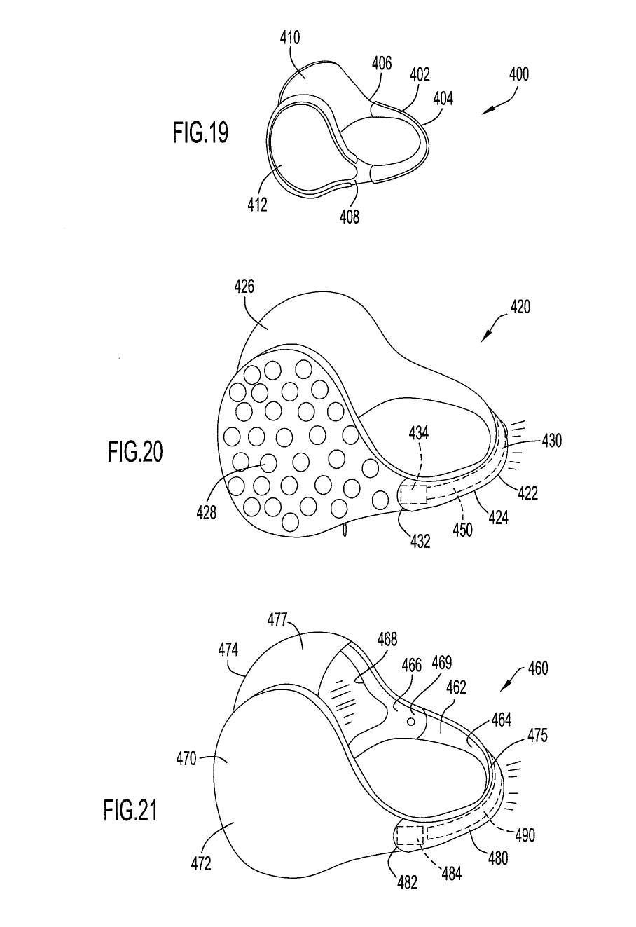

An alternative embodiment of an ear covering device according to the present invention is illustrated in FIG. 20. Ear covering device 420 includes a shell 422 that is configured to define an interior region in which a frame is disposed. Shell 422 can be used with frame 402, which is illustrated in FIG. 19. Shell 422 covers the inner side and the outer side of the frame.

The shell 422 includes a middle or band portion 424 and ear portions 426 and 428 at opposite ends of the middle portion 424. A sleeve 430 is coupled to the shell 422. The sleeve 430 and the outer surface of the shell 422 form a receptacle therebetween in which a light source 450 can be inserted. The sleeve 430 has an end 432 and a coupler 434 that can be coupled to the shell 422 or a coupler on the shell 422 to close access to the receptacle.

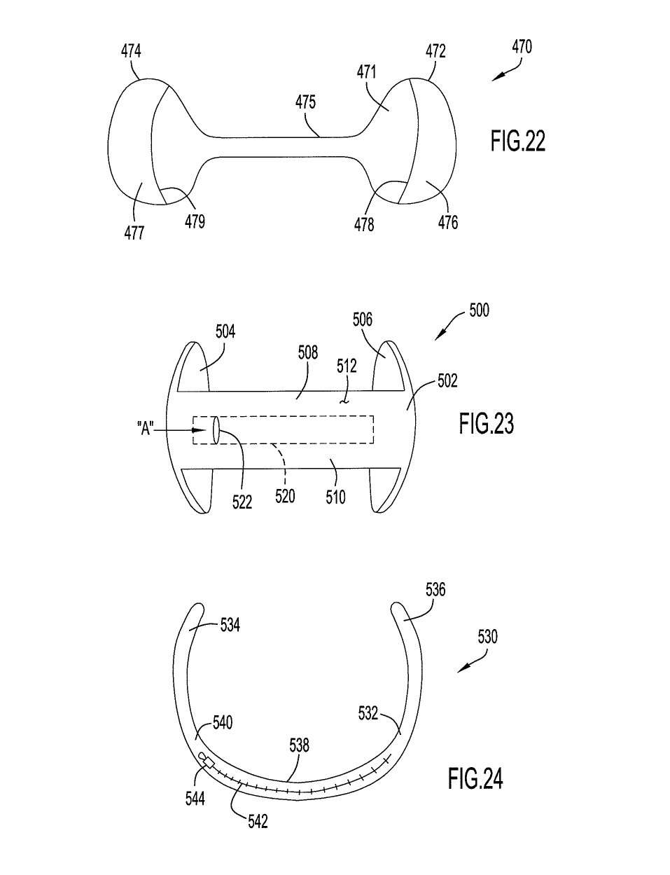

An alternative embodiment of an ear covering device according to the present invention is illustrated in FIGS. 21-22. FIG. 21 illustrates a perspective view of the ear covering device 460 and FIG. 22 illustrates a plan view of the inner surface of the shell 470 of the ear covering device 460 disposed in a planar configuration.

Referring to FIG. 21, the ear covering device 460 includes a frame 462 that has a band portion 464 and two ear portions (only ear portion 466 is visible in FIG. 21) coupled to the band portion 464. Ear portion 466 includes an inner surface 468 that defines an opening in the ear portion 466. The ear portion 466 is pivotally coupled to the band portion 464 by a connector 469, such as a rivet or screw.

Ear covering device 460 includes a shell 470 that has ear portions 472 and 474 and a middle portion 475. The shell 470 has a main body 471 and coupling portions 476 and 477 with edges 478 and 479, respectively (see FIG. 22). The coupling portions 476 and 477 are attached to the main body 471 using any conventional technique, such as sewing, bonding or welding. As shown in FIG. 21, coupling portion 477 is used to capture the frame ear portion 466 between the coupling portion 477 and the corresponding section of the main body 471 of the shell 470. In a similar manner, coupling portion 476 is used to capture the corresponding frame ear portion between the coupling portion 476 and the main body 471.

The ear covering device 460 also includes a coupling mechanism, which is a sleeve 480. The sleeve 480 includes an open end 482 through which a light source 490 can be inserted. A coupler 484 is provided to allow a user to open and close the open end 482. As shown, when the light source 490 is powered, light is generated and passes through the sleeve 480.

An alternative embodiment of an ear covering device according to the present invention is illustrated in FIG. 23. The ear covering device 500 includes a shell 502 that has ear portions 504 and 506 and a middle or band portion 508 disposed therebetween. The middle portion 508 includes an outer membrane 510 with an outer surface 512. Internal to the shell 502 is a receptacle 520 that can be formed by stitching or tacking. Alternatively, the receptacle 520 can be formed by coupling a piece of material to an inner surface of the outer membrane.

An opening 522 is formed in the outer membrane 510. The opening 522 is in communication with the receptacle 520. A light source (not shown) can be inserted through the opening 522 into the receptacle 520 along the direction of arrow “A.” In this embodiment, there is no extra sleeve provided with the shell 502. The illumination device is inserted into the shell 502, which preferably is made of a translucent material. The shell 502 of ear covering 500 can be used with any configuration or style of frame.

An alternative embodiment of an ear covering device according to the invention is illustrated in FIG. 24. Ear covering device 530 includes a shell 532 with ear portions 534 and 536 and a middle or band portion 538 disposed therebetween. As shown in FIG. 24, which is a bottom view of ear covering device 530, the shell 532 has a lower surface 540 that defines an opening 542 extending along a portion of its length. The opening 542 is shown in a closed configuration.

The opening 542 is in communication to the interior region of the shell 532. A closure mechanism 544, such as a zipper, is provided to allow a user to open and close the opening 542. The opening 542 is configured to allow a light source to be inserted therethrough. Additionally, the opening 542 may be configured to have a sufficient length to permit a frame to be inserted therethrough and into the interior region of the shell 532.

In alternative embodiments, the location of the opening 542 can vary. For example, the opening can be formed on the upper surface, in the middle of a surface, or on a side surface.

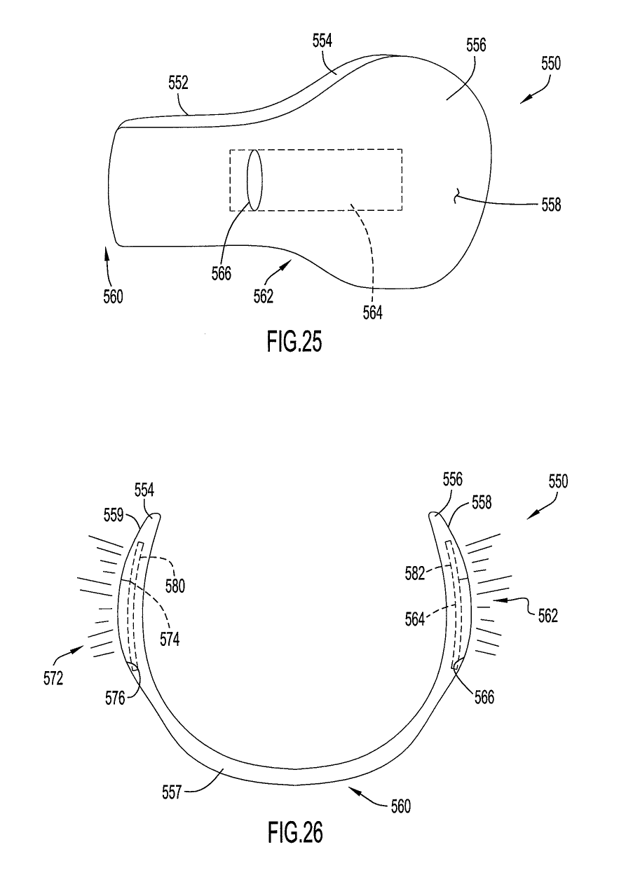

An alternative embodiment of an ear covering device according to the invention is illustrated in FIGS. 25-26. The ear covering device 550 includes a shell 552 with ear portions 554 and 556 and a middle portion 557. Surrounding the ear covering device 550 is a rear region or area 560 and side regions or areas 562 and 572. Instead of on the middle portion 557, the receptacles 564 and 574 are formed in the ear portions 556 and 554 of the shell 552, respectively. Openings 566 and 576 are provided in the side surfaces 558 and 559 of the ear portions 556 and 558, respectively. The openings 566 and 576 are in communication with the receptacles 564 and 574, respectively, and are configured to have light sources 582 and 580, respectively, inserted therethrough.

In different embodiments, the locations of the lights sources on the sides of the ear covering device 550 can vary. Similarly, the size, the shape, and the configuration of the light sources can vary in alternative embodiments.

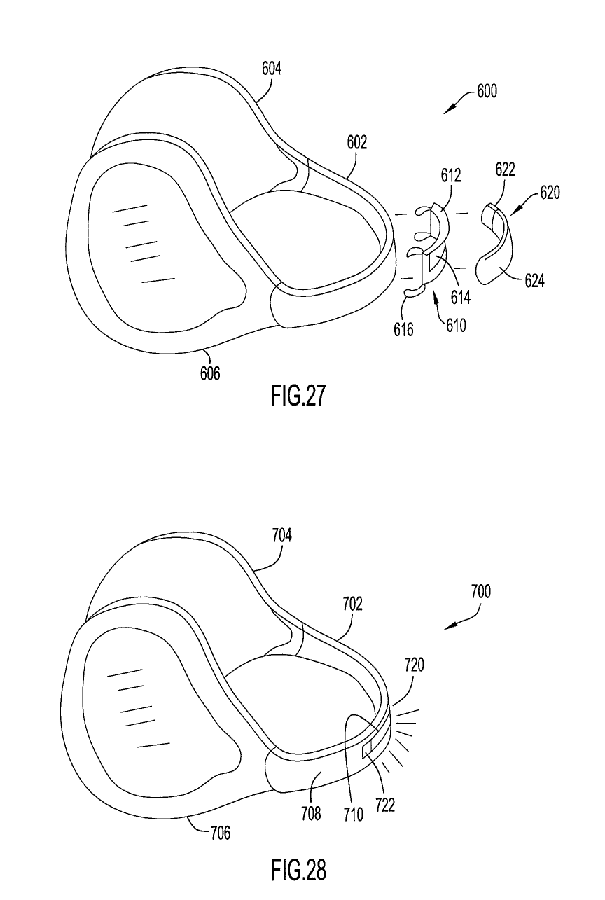

An alternative embodiment of an ear covering device according to the present invention is illustrated in FIG. 27. Ear covering device 600 includes a frame with a band portion 602 and ear portions 604 and 606. Ear covering device 600 has a coupling mechanism 610 that can be coupled to and removed from the band portion 602. The coupling mechanism 610 has a frame 612 with an opening 614 that is configured to receive a light source 620. The frame 612 has several couplers 616 connected thereto. The couplers 616 can be used to snap the frame 612 on to the band portion 602. The light source 620 includes a housing 622 and an elongate member 624 that can be illuminated as previously described. The light source 620 is configured to be received and supported by the frame 612.

An alternative embodiment of an ear covering device according to the present invention is illustrated in FIG. 28. Ear covering device 700 includes a frame with a band portion 702 and ear portions 704 and 706. The band portion 702 has an outer surface 708 in which a cavity or recess 710 is formed. A light source 720 is configured so that it can be inserted into the recess 710 and supported by the band portion 702. In an alternative embodiment, the light source 720 can be formed so that it is part of the band portion 702 at the time of manufacture. For example, the light source 720 can be molded into the band portion 702 and positioned so that it generates light in an outward direction from the band portion 702. In this embodiment, the light source 720 includes a switch 722 that can be actuated to control the light generated by the light source 720.

This embodiment is just one of the several examples disclosed herein that provide for a light source, such as an LED, on the back side of a user's head. That location for a light source is beneficial so that a person approaching an individual from rear can see the light source and be warned of the position and movement of the individual.

In various embodiments, the characteristics of the light source can vary. In one embodiment, the light source can be visible for up to 1,000 feet. The power source can vary as well. In one embodiment, the power source can be a battery that can last for approximately 150 hours. In different embodiments of ear covering devices according to the invention, the locations and quantity of light sources can vary.

Thus, it is intended that the present invention cover the modifications and variations of this invention. For example, it is to be understood that terms such as “left,” “right,” “top,” “bottom,” “front,” “rear,” “side,” “height,” “length,” “width,” “upper,” “lower,” “interior,” “exterior,” “inner,” “outer,” and the like as may be used herein, merely describe points of reference and do not limit the present invention to any particular orientation or configuration.

While the invention has been described in detail and with references to specific embodiments thereof, it will be apparent to one skilled in the art that various changes and modifications can be made therein without departing from the spirit and scope thereof. Thus, it is intended that the present invention covers the modifications and variations of this invention.

What is claimed is:

1. An ear covering device comprising:
a frame, the frame including a first ear portion, a second ear portion, and a middle portion, the middle portion being disposed between the first ear portion and the second ear portion;
a fabric shell, the fabric shell including its own first ear portion, second ear portion, and middle portion, the middle portion of the fabric shell being disposed between the first ear portion of the fabric shell and the second ear portion of the fabric shell, the fabric shell being configured to cover a portion of the frame; and
a light source, the light source being configured to emit light, the light source being configured to extend along a portion of the fabric shell.

2. The ear covering device of claim 1, wherein the fabric shell has an inner side and an outer side, and the light source is disposed on the outer side of the fabric shell.

3. The ear covering device of claim 1, wherein the light source is coupled to the middle portion of the fabric shell.

4. The ear covering device of claim 1, wherein the light source is located along a rear of the fabric shell.

5. The ear covering device of claim 1, wherein the frame includes a first side region, a second side region, and a rear region, the first side region being proximate to the first ear portion of the frame, the second side region being proximate to the second ear portion of the frame, the rear region being proximate to the middle portion of the frame, and the light source extends along the rear region.

6. The ear covering device of claim 1, wherein the frame includes a first side region, a second side region, and a rear region, the first side region being proximate to the first ear portion of the frame, the second side region being proximate to the second ear portion of the frame, the rear region being proximate to the middle portion of the frame, and a portion of the light source is disposed proximate to one of the first side region and the second side region.

7. The ear covering device of claim 1, further comprising:
a coupling mechanism, the coupling mechanism being configured to couple the light source to the fabric shell, the coupling mechanism forming a receptacle with the fabric shell and being configured to receive the light source.

8. An accessory with an illumination device comprising:
an ear covering device, the ear covering device being configured to extend around the back of a user's head, the ear covering device including a first ear portion, a second ear portion, and a middle portion, the middle portion being disposed between the first ear portion and the second ear portion; and
a light source, the light source being configured to emit light, the light source being coupleable to the ear covering device, the light source extending along the middle portion of the ear covering device.

9. The accessory of claim 8, wherein the ear covering device includes a frame and a fabric shell, the fabric shell is configured to cover a portion of the frame, and the light source is configured to be coupled to the fabric shell.

10. The accessory of claim 9, wherein the fabric shell includes an inner side and an outer side, the inner side being disposed proximate to a user when the ear covering device is disposed on the user's head, the outer side being disposed away from the user when the ear covering device is disposed on the user's head, the accessory further comprising:
a coupling mechanism, the coupling mechanism being disposed on the outer side of the fabric shell.

11. The accessory of claim 10, wherein the coupling mechanism has a first end and a second end, the first end of the coupling mechanism is coupled to the fabric shell, and the second end of the coupling mechanism is releaseably coupleable to the fabric shell.

12. The accessory of claim 11, wherein the second end of the coupling mechanism includes a coupler attached thereto, the coupler being configured to close the receptacle.

13. The accessory of claim 10, wherein the coupling mechanism includes a sleeve, the sleeve is coupled to the fabric shell, the sleeve and an outer surface of the fabric shell forming a receptacle therebetween, the receptacle being configured to receive the light source therein.

14. The accessory of claim 13, wherein the sleeve is a lightweight, translucent material.

15. The accessory of claim 13, wherein the middle portion of the ear covering device has a height dimension, the sleeve has its own height dimension when the sleeve is coupled to the fabric shell, and the height dimension of the sleeve is less than the height dimension of the middle portion of the ear covering.

16. The accessory of claim 9, wherein the fabric shell includes an inner side and an outer side, the inner side being disposed proximate to a user when the ear covering device is disposed on the user's head, the outer side being disposed away from the user when the ear covering device is disposed on the user's head, the ear covering device further comprising:
a coupling mechanism, the coupling mechanism being disposed within the interior region of the fabric shell.

17. The accessory of claim 16, wherein the fabric shell includes an inner membrane and an outer membrane, and the coupling mechanism includes a receptacle formed between the inner membrane and the outer membrane.

18. The accessory of claim 8, wherein the ear covering device includes a first side region, a second side region, and a rear region, the first side region being proximate to the first ear portion, the second side region being proximate to the second ear portion, the rear region being disposed proximate to the middle portion, and the light source extends along the rear region.

19. An ear protection device comprising:
a frame, the frame including a first ear portion, a second ear portion, and a middle portion, the middle portion being disposed between the first ear portion and the second ear portion;
a fabric shell, the fabric shell including its own first ear portion, second ear portion, and middle portion, the middle portion of the fabric shell being disposed between the first ear portion of the fabric shell and the second ear portion of the fabric shell, the fabric shell being configured to cover a portion of the frame; and
a light component, the light component including a light source that is configured to emit light, the light component being configured to removably couple the light source to the fabric shell.

20. The ear protection device of claim 19, wherein the middle portion of the fabric shell defines a rear region of the ear protection device, and the light source is removably coupleable to extend along a portion of the rear region.
